(19) United States
(12) Patent Application Publication
(10) Pub. No.: US 2012/0121947 A1
(43) Pub. Date: May 17, 2012

(54) LITHIUM SECONDARY BATTERY

(76) Inventors: Norio Iwayasu, Hitachinaka (JP); Jinbao Zhao, Xiamen (CN); Hidetoshi Honbo, Hitachinaka (JP); Shinji Yamada, Tsukuba (JP)

(21) Appl. No.: 13/296,268

(22) Filed: Nov. 15, 2011

(30) Foreign Application Priority Data
Nov. 15, 2010 (JP) 2010-254352

(51) Int. Cl. H01M 10/44; C08F 212/32; C08F 220/28; H01M 10/0564

(52) U.S. Cl. 429/61; 429/341; 526/309; 526/320

(57) ABSTRACT

To provide a functional material which forms a high-resistance layer to interrupt an electric current, thereby ensuring the safety of a battery during overcharge.

A polymerizable compound including a polymerizable functional group having an aromatic functional group, a polymerizable compound including a polymerizable functional group having a highly polar functional group, and a polymerizable compound including a polymerizable functional group having a less polar functional group, or a polymer obtained by polymerizing these polymerizable compounds are added into an electrolytic solution of a lithium secondary battery.

### CLAIM OF PRIORITY

The present application claims priority from Japanese Patent application serial No. 2010-254352, filed on Nov. 15, 2010, the content of which is hereby incorporated by reference into this application.

### BACKGROUND OF THE INVENTION

1. Field of the Invention

The present invention relates to a lithium secondary battery.

2. Description of Related Art

Lithium ion batteries have high energy density. They have been widely used for notebook computers, cellular phones and so on, making use of their characteristic features. Recently, the application of lithium ion batteries is studied also as a power source of an electric vehicle with a growing interest in the electric vehicle from the viewpoint of the prevention of global warming associated with an increase in carbon dioxide.

Although the lithium ion battery has the above-described excellent characteristic features, it also has challenges, one of which is improvement in safety. Especially, the ensuring of safety during overcharge is an important challenge.

When the lithium battery is overcharged, thermal stability of the battery may decrease, leading to a decrease in the safety of the battery. A current lithium ion battery therefore installs a control circuit for detecting an overcharged state and for interrupting charging, thereby ensuring safety. Detection of an overcharged state is performed by monitoring a battery voltage. However, since a difference between the operating voltage of a battery and its voltage in an overcharged state is small, it has been difficult to appropriately detect overcharge by the control circuit. In addition, in the event of a fault in the control circuit, there is a possibility of overcharge, and the ensuring of safety of the lithium ion battery itself during overcharge becomes important.

Patent Document 1 (Japanese Patent Application Laid-Open Publication No. 2009-032635) discloses a polymer electrolyte secondary battery including a polymer electrolyte containing a polymer, a nonaqueous solvent and a lithium salt in order to increase the safety of a battery during overcharge, in which the nonaqueous solvent contains at least either one of ethylene carbonate and propylene carbonate.

Patent Document 2 (Japanese Patent Application Laid-Open Publication No. 2007-172968) discloses an electrolyte containing trans-stilbene in order to increase thermal stability during overcharge.

Patent Document 3 (Japanese Patent Application Laid-Open Publication No. 2003-297425) discloses a nonaqueous electrolyte containing an aromatic compound and a fluoride of an ether derivative in order to provide a nonaqueous electrolyte battery having stable performance and high energy density.

Patent Document 4 (Japanese Patent Application Laid-Open Publication No. 2002-260738) discloses a nonaqueous electrolyte battery containing a polymer electrolyte which is formed by hardening a composite having an acryloyl group and contains a nonaqueous electrolyte and a radical polymerization initiator which can extract the hydrogen of the acryloyl group when the cathode potential becomes 4.4 V or over in order to provide a nonaqueous electrolyte battery having excellent balance between energy density and battery characteristics while improving safety.

### SUMMARY OF THE INVENTION

In the lithium secondary battery of the present invention, an electrolyte contains a polymerizable compound including a polymerizable functional group having an aromatic functional group, a polymerizable compound including a polymerizable functional group having a highly polar functional group, and a polymerizable compound including a polymerizable functional group having a less polar functional group, or a polymer obtained by polymerizing these polymerizable compounds.

According to the present invention, safety during overcharge can be improved without degrading the performance of a battery.

### BRIEF DESCRIPTION OF THE DRAWINGS

FIG. 1 is an exploded perspective view showing a secondary battery of an embodiment.

FIG. 2 is a cross-section view showing a secondary battery of another embodiment.

FIG. 3 is a perspective view showing a secondary battery of another embodiment.

FIG. 4 is an A-A cross-section view of FIG. 3.

### DETAILED DESCRIPTION OF THE PREFERRED EMBODIMENTS

We have found out an overcharge inhibitor which undergoes reaction when cathode potential rises during overcharge to increase the internal resistance of a battery as a result of our earnest study. The overcharge inhibitor has high electrochemical stability within the operating voltage of the battery and can be used without impairing battery performance.

The polymer electrolyte described in Patent Document 1 has a drawback in which its low ion conductivity increases the internal resistance of the battery, thereby degrading battery performance.

The trans-stilbene described in Patent Document 2 has a reactive double bond, which may cause degradation in battery performance.

In the nonaqueous electrolyte described in Patent Document 3 the aromatic compounds undergo electropolymerization on a high-potential cathode to consume a charging current during overcharge, thereby controlling the charging reaction of the battery. However, when all the aromatic compounds have undergone electropolymerization, the charging reaction of the battery resumes. The effect of increasing the internal resistance of the battery by the electropolymerized product of the aromatic compounds contained in the nonaqueous electrolyte described in Patent Document 3 is low.

An object of the present invention is to provide a functional material which forms a high-resistance layer to interrupt a current and ensures the safety of a battery during overcharge.

Hereinafter, a lithium secondary battery of an embodiment of the present invention and a polymerizable compound or a polymer contained therein, and an overcharge inhibitor for the lithium secondary battery or an electrolytic solution for the lithium secondary battery (also simply referred to as an electrolytic solution) will be described.

The above lithium secondary battery includes a cathode, an anode, and an electrolyte, in which the electrolyte contains a polymerizable compound represented by the following chemical formula (1) or (2), a polymerizable compound represented by the following chemical formula (3), and a polymerizable compound represented by the following chemical formula (4).

Z¹—X-A chemical formula (1)

Z¹-A chemical formula (2)

Z²—Y chemical formula (3)

Z³—W chemical formula (4)

In the above chemical formulae (1) and (2), Z¹ is a polymerizable functional group, X is a hydrocarbon group or an oxyalkylene group having a carbon number of 1 to 20, and A is an aromatic functional group.

In the above chemical formula (3), Z² is a polymerizable functional group, and Y is a highly polar functional group.

In the above chemical formula (4), Z³ is a polymerizable functional group, and W is a less polar functional group.

Although the polymerizable functional group is not especially limited as far as it causes a polymerization reaction, an organic group having an unsaturated double bond such as a vinyl group, acryloyl group and methacryloyl group is preferably used.

The hydrocarbon having a carbon number of 1 to 20 includes an aliphatic hydrocarbon group such as a methylene group, an ethylene group, a propylene group, an isopropylene group, a butylene group, an isobutylene group, a dimethylethylene group, a pentylene group, a hexylene group, a heptylene group, an octylene group, an isooctylene group, a decylene group, an undecylene group and a dodecylene group, and an alicyclic hydrocarbon group such as a cyclohexylene group and a dimethylcyclohexylene group. The oxyalkylene group includes an oxymethylene group, an oxyethylene group, an oxypropylene group, an oxybutylene group and an oxytetramethylene group.

The aromatic functional group is a functional group having a carbon number of 20 or less satisfying the Huckel's rule. Specifically, it includes a cyclohexylbenzyl group, a biphenyl group, a phenyl group, a naphthyl group as its condensate, an anthryl group, a phenanthryl group, a triphenylene group, a pyrene group, a chrysene group, a naphthacene group, a picene group, a perylene group, a pentaphene group, pentacene group and an acenaphthylene group. Part of these aromatic functional groups may be substituted. The aromatic functional group may include an element other than carbon, or specifically an element such as S, N, Si and O within the aromatic ring. From the viewpoint of electrochemical stability, a phenyl group, a cyclohexylbenzyl group, a biphenyl group, a naphthyl group, an anthracene group and a tetracene group are preferred, and a cyclohexylbenzyl group and a biphenyl group are especially preferred.

The above polymer is obtained by polymerizing the polymerizable compounds contained in the above lithium secondary battery. In other words, the above polymer is obtained by polymerizing the polymerizable compounds represented by the chemical formulae (1), (3) and (4), or the polymerizable compounds represented by the chemical formulae (2), (3) and (4).

The polymer is represented by the following chemical formula (5) or (6).

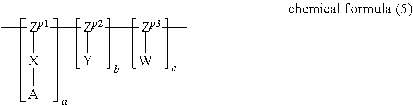

In the above chemical formula (5), Z^{p1} is a residue of a polymerizable functional group, X is a hydrocarbon group or an oxyalkylene group having a carbon number of 1 to 20, A is an aromatic functional group, Z^{p2} is a residue of a polymerizable functional group, Y is a highly polar functional group, Z^{p3} is a residue of a polymerizable functional group, W is a less polar functional group, and a, b and c represent mol %.

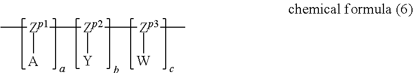

In the above chemical formula (6), Z^{p1} is a residue of a polymerizable functional group, A is an aromatic functional group, Z^{P2} is a residue of a polymerizable functional group, Y is a highly polar functional group, Z^{p3} is a residue of a polymerizable functional group, W is a less polar functional group, and a, b and c represent mol %.

The above polymer is represented by the following chemical formula (7).

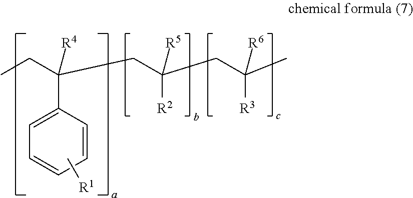

In the above chemical formula (7), R¹ is a hydrogen atom, an aliphatic hydrocarbon, an alicyclic hydrocarbon, or an aromatic group, R² is a functional group having alkylene oxide, a cyano group, an amino group, or a hydroxyl group, R³ is a functional group having an aliphatic hydrocarbon or an alicyclic hydrocarbon group, R⁴, R⁵ and R⁶ are each a hydrogen atom or a hydrocarbon group, and a, b and c represent mol %.

For the above overcharge inhibitor for the lithium secondary battery, the above polymerizable compounds or the above polymer can be used as an active component.

Although any one of the above polymerizable compound and polymer can be used for the above overcharge inhibitor for the lithium secondary battery, it is preferred from the viewpoint of electrochemical stability that the polymer obtained by polymerizing the polymerizable compounds in advance to prepare the polymer and then purifying it.

Polymerization may be any one of bulk polymerization, solution polymerization and emulsion polymerization which are previously known. As a polymerization method, radical polymerization is preferably used although the polymerization method is not specially limited. In the polymerization, a polymerization initiator may or may not be used, but a radical polymerization initiator is preferably used from the viewpoint of ease of handling. A polymerization method using the radical polymerization initiator can be performed with a normally employed temperature range and polymerization time.

The additive amount of the polymerization initiator is 0.1 to 20 wt % with respect to the polymerizable compound, and preferably is 0.3 to 5 wt %. The radical polymerization initiator includes organic peroxides such as t-butyl peroxypivalate, t-hexyl peroxypivalate, methyl-ethyl ketone peroxide, cyclohexanone peroxide, 1,1-bis(t-butyl peroxy)-3,3,5-trimethyl cyclohexane, 2,2-bis(t-butyl peroxy) octane, n-butyl-4,4-bis(t-butyl peroxy) valerate, t-butyl hydroperoxide, cumene hydroperoxide, 2,5-dimethyl hexane-2,5-dihydroperoxide, di-t-butyl peroxide, t-butyl cumyl peroxide, dicumyl peroxide, α,α′-bis(t-butyl peroxy-m-isopropyl)benzene, 2,5-dimethyl-2,5-di(t-butyl peroxy)hexane, 2,5-dimethyl-2,5-di(t-butyl peroxy)hexane, benzoyl peroxide, and t-butyl peroxy propyl carbonate, and azo compounds such as 2,2′-azobisisobutyronitrile, 2,2′-azobis(2-methyl butyronitrile), 2,2′-azobis(4-methoxy-2,4-dimethyl valeronitrile), 2,2′-azobis(2,4-dimethyl valeronitrile), 1,1′-azobis(cyclohexane-1-carbonitrile), 2-(carbamoylazo) isobutyronitrile, 2-phenylazo-4-methoxy-2,4-dimethyl valeronitrile, 2-2-azobis(2-methyl-N-phenylpropionamidine) dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl) propionamidine]dihydrochloride, 2,2′-azobis[2-methyl-N-(2-propenyl)propionamidine]dihydrochloride, 2,2′-azobis(2-methylpropionamidine) dihydrochloride, 2,2′-azobis[N-(2-hydroxyethyl)-2-methylpropionamidine]dihydrochloride, 2,2′-azobis[2-(5-methyl-2-imidazoline-2-yl)propane]dihydrochloride, 2,2′-azobis[2-(2-imidazoline-2-yl) propane]dihydrochloride, 2,2′-azobis[2-(4,5,6,7-tetrahydro-1H-1,3-diazepine-2-yl) propane]dihydrochloride, 2,2′-azobis[2-(3,4,5,6-tetrahydropyrimidine-2-yl)propane]dihydrochloride, 2,2′-azobis[2-(5-hydroxy-3,4,5,6-tetrahydropyrimidine-2-yl propane]dihydrochloride, 2,2′-azobis{2-[1-(2-hydroxyethyl)-2-imidazoline-2-yl]propane}dihydrochloride, 2,2′-azobis[2-(2-imidazoline-2-yl)propane], 2,2′-azobis{2-methyl-N-[1,1-bis(hydroxymethyl)-2-hydroxyet hyl]propionamide}, 2,2′-azobis{2-methyl-N-[1,1-bis(hydroxymethyl)ethyl]propionamide}, 2,2′-azobis[2-methyl-N-(2-hydroxyethyl) propionamide], 2,2′-azobis(2-methylpropionamide) dehydrate, 2,2′-azobis(2,4,4-trimethylpentane), 2,2′-azobis(2-methylpropane), dimethyl 2,2′-azobisisobutylate, 4,4′-azobis(4-cyano-valeric acid), and 2,2′-azobis[2-(hydroxymethyl) propionitrile].

Y in the above chemical formula (3) is a highly polar functional group. The highly polar functional group includes an oxyalkylene group [(AO)ₘR], a cyano group, an amino group, a hydroxyl group and a thiol group. Affinity to an electrolytic solution can be increased by applying the highly polar functional group.

In the oxyalkylene group, it is preferable that AO is ethylene oxide, R is methyl, and m is 1 to 20, preferably 1 to 10, and more preferably 1 to 5.

Z³ in the above chemical formula (4) is a polymerizable functional group. The polymerizable functional group is not specially limited as far as it causes a polymerization reaction, but an organic group having an unsaturated double bond such as a vinyl group, an acryloyl group or methacryloyl group is preferably used. W in the above chemical formula (4) is a less polar group. The less polar group includes an aliphatic hydrocarbon group and an alicyclic hydrocarbon group. The aliphatic hydrocarbon group includes a hydrocarbon group such as a methyl group, an ethyl group, a propyl group and a butyl group, and a branched hydrocarbon group such as an isopropyl group and a tertiary butyl group. The cyclic hydrocarbon group includes a cyclopropylene group, a cyclobutylene group, a cyclopentyl group and a cyclohexyl group. A film with higher resistance can be formed during overcharge by introducing the less polar group to improve the safety of a battery. From the viewpoint of formation of a high-resistance film, the less polar group is preferably a methyl group, an ethyl group, a propyl group, a butyl group or a cyclohexyl group. The aromatic functional group can be reduced while maintaining the overcharge inhibiting effect by introducing the less polar group to improve high-temperature storage characteristics, too.

The letters a, b and c in the above chemical formulae (5), (6) and (7) represent mol %, wherein 0<a≦100, 0≦b<100 and 0≦c<100.

To obtain the effect of the present invention, a, b and c are important. When the mol % of a and c is small, the performance of the high-resistance film formed during overcharge degrades. When the mol % of a and c increases, the solubility becomes hard to be solved in the electrolytic solution, decreasing the effect of the present invention. From the foregoing viewpoint, a is preferably 5 to 50% and more preferably 10 to 40%, and c is preferably 3 to 50% and more preferably 5 to 30%.

Although the existence form of the above polymerizable compounds and the above polymer within the lithium secondary battery is not especially limited, they preferably coexist in the electrolytic solution.

The electrolytic solution may be a solution of the above polymerizable compounds and the above polymer or may be a suspension of the above polymerizable compounds and the above polymer.

The concentration of the polymerizable compounds and polymer calculated in the following calculation formula (1) is 0 to 100%, preferably 0.01 to 5%, and more preferably 1 to 3%.

Concentration [wt %]=(mass of the polymerizable compounds and polymer)/(mass of the electrolytic solution+mass of the polymerizable compounds and polymer)×100 Calculation Formula (1)

The larger the value, the lower the ion conductivity of the electrolytic solution. It leads to a decrease in the battery performance. The smaller the value, the lower the effect of forming the high-resistance layer to interrupt an electric current.

In the above polymer, the number-average molecular weight (Mₙ) is 5×10⁷ or less, and preferably 1×10⁶, and more preferably 1×10⁵. Using a polymer having a lower Mₙ can reduce the decrease of the battery performance.

The above electrolytic solution is obtained by solving a supporting electrolyte into a nonaqueous solvent. Although the nonaqueous solvent is not especially limited as far as it solves the supporting electrolyte, the following ones are preferable. They are organic solvents such as diethyl carbonate, dimethyl carbonate, ethylene carbonate, ethyl methyl carbonate, propylene carbonate, γ-butyl lactone, tetrahydrofuran and dimethoxyethane. One of them or two or more thereof in combination may be used.

Although the supporting electrolyte is not especially limited as far as it can be solved into the nonaqueous solvent, the following ones are preferable. They are electrolytic salts such as LiPF_{G}, LiN(CF₃SO₂)₂, LiN(C₂F₆S^{O}₂)₂, LiClO₄, LiBF₄, LiAsF₆, LiI, LiBr, LiSCN, Li₂B₁₀Cl₁₀ and LiCF₃CO₂. One of them or two or more thereof in combination may be used. Vinylene carbonate or the like may be added to the electrolytic solution.

The cathode for use in the lithium secondary battery which can occlude and release lithium ions is represented by a general formula LiMO₂ (M is a transition metal). For example, it includes a laminar-structured oxide such as LiCoO₂, LiNiO₂, LiMn_{1/3}Ni_{1/3}CO_{1/3}O₂ and LiMn_{0.4}Ni_{0.4}CO_{0.2}O₂, and an oxide obtained by substituting at least one metallic element selected from the group consisting of Al, Mg, Mn, Fe, Co, Cu, Zn, Al, Ti, Ge, W and Zr for part of M. It also includes a Mn oxide having a spinel type crystal structure such as LiMn₂O₄ and Li₁₊ₓMn₂₋ₓO₄. Another option is the use of LiFePO₄ or LiMnPO₄ having an olivine structure.

For the anode for use in the lithium secondary battery, a material obtained by heat-treating a graphitizable material obtained from natural graphite, petroleum coke, coal pith coke or the like at high temperatures of 2500° C. or over; mesophase carbon, amorphous carbon, carbon fiber; a metal which forms an alloy with lithium; and a material supporting a metal on the surface of carbon particles are used. For example, it is a metal or an alloy selected from the group consisting of lithium, silver, aluminum, tin, silicon, indium, gallium and magnesium. The oxide of the metal can be used as the anode. In addition, lithium titanate can be used, too.

For a separator for use in the lithium secondary battery, a material formed of a polymer such as polyolefin, polyamide and polyester, a glass cloth using fibrous glass fiber or the like can be used. Although its material properties are not limited as far as it is a reinforcing material which does not adversely affect the lithium battery, polyolefin is preferably used.

The polyolefin includes polyethylene, polypropylene or the like, and films formed of these materials can be laminated to be used.

The air permeability (sec/100 mL) of the separator is 10 to 1000, preferably 50 to 800, and more preferably 90 to 700.

An overcharge inhibitor undergoes reaction at a certain voltage to reduce overcharge. The reaction is a voltage which is the operating voltage of the battery or over. Specifically, the voltage is 2 V or over based on Li/Li⁺, and preferably 4.4 V or over. When the value of the voltage is too small, the overcharge inhibitor is decomposed within the battery, thereby decreasing the battery performance.

A method for producing a polymer in accordance with one embodiment of the present invention and a lithium secondary battery and its charge control method will then be described.

The above method for producing the polymer includes the steps of mixing a polymerizable compound represented by the above chemical formula (1) or chemical formula (2), and polymerizable compounds represented by the above chemical formulae (3) and (4), and mixing a polymerization initiator thereinto to cause a reaction.

The above method for producing the polymer includes the steps of mixing polymerizable compounds represented by the above chemical formulae (8), (9) and (10), and mixing a polymerization initiator thereinto to cause a reaction.

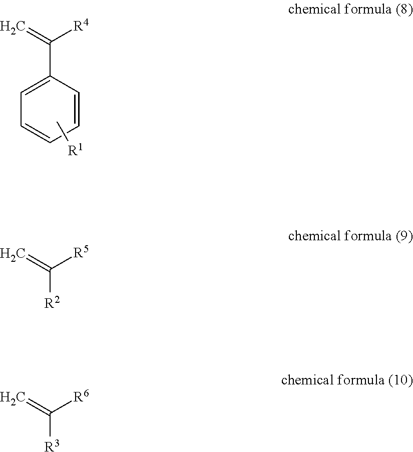

In the chemical formulae, R¹ is a hydrogen atom, an aliphatic hydrocarbon, an alicyclic hydrocarbon or an aromatic group, R² is a functional group having alkylene oxide, a cyano group, an amino group or a hydroxyl group, R³ is a functional group having an aliphatic hydrocarbon or an alicyclic hydrocarbon, and R⁴, R⁵ and R⁶ are each a hydrogen atom or a hydrocarbon group.

The polymerizable compounds represented by the above chemical formulae (8), (9) and (10) contain a vinyl group having an unsaturated double bond as a polymerizable functional group. The benzene ring (the aromatic functional group) to which R¹ bonds corresponds to A in the above chemical formulae (1) and (2). R² corresponds to Y in the above chemical formula (3). R³ corresponds to W in the above chemical formula (4).

The above charge control method for a lithium secondary battery includes the steps of using the electrolytic solution containing the above polymerizable compound or the above polymer, determining the completion of charge by detecting an increase in overvoltage, and terminating the application of voltage.

The above lithium secondary battery uses the electrolytic solution containing the above polymerizable compound or the above polymer and has a control unit which determines the completion of charging by detecting an increase in overvoltage and terminates the application of voltage.

Hereinafter, the present invention will be described more specifically with embodiments, but the present invention will not by limited by these embodiments.

### <Electrode Manufacturing Method>

### <Cathode>

CELLSEED (lithium cobaltate made by Nippon Chemical Industrial Co., Ltd.), SP270 (graphite made by Nippon Graphite Industries Ltd.) and KF1120 (polyvinylidene fluoride made by Kureha Corporation) were mixed with a proportion of 85:10:10 by weight, and were mixed into N-methyl-2-pyrolidone to prepare a slurry solution. The slurry was coated on an aluminum foil with a thickness of 20 μm by a doctor blade method and was dried. The amount of coated mixture was 100 g/m². It was pressed to provide a mixture bulk density of 2.7 g/cm³, and was cut out in a circular electrode with a radius of 0.75 cm to prepare a cathode.

### <Anode>

For an anode, (i) Li metal (made by Honjo Metal Co., Ltd.) or an electrode shown in the following (ii) was used.

(ii) CARBOTRON PE (amorphous carbon made by Kureha Corporation) and KF1120 (polyvinylidene fluoride made by Kureha Corporation) were mixed with a proportion of 90:10 by weight to prepare a mixture, which was then mixed into N-methyl-2-pyrolidone to prepare a slurry solution. The slurry was coated on a copper foil with a thickness of 20 μm by the doctor blade method and was dried. The amount of coated mixture was 40 g/m². It was pressed to provide a mixture bulk density of 1.0 g/cm³, and was cut out in a circular electrode with a radius of 0.75 cm to prepare an anode.

### <Battery Fabrication Method>

A separator made of polyolefin is inserted into between the cathode and the anode to form an electrode group, and the electrolytic solution was injected thereto. The battery was then sealed with an aluminum laminate to fabricate a battery.

### <Battery Evaluation Method>

### 1. Battery Initialization Method

The fabricated battery was charged with a current density of 0.45 mA/cm² up to 4.3 V, and was then discharged to 3 V. The cycle was performed three times to initialize the battery. The discharge capacity at the third cycle was defined to be the battery capacity of the battery. During discharge at the third cycle, a DC resistance (R) was determined from a voltage drop (ΔE) after a lapse of five seconds from the start of discharge and a current value (I) during the discharge.

### 2. Cycle Test

The fabricated battery was charged with a current density of 0.45 mA/cm² up to 4.3 V, and was then discharged to 3 V. The charge/discharge cycle was repeated to perform a cycle test. A cycle characteristic was evaluated by taking the ratio of the discharge capacity at the first cycle to the discharge capacity after a lapse of 50 cycles.

### 3. High-Temperature Storage Test

A battery fabricated separately was preliminarily charged with a current density of 0.45 mA/cm² up to 4.3 V. It was then stored at 60° C. for three days. After storage, the battery was discharged, and the discharge capacity obtained at that time was defined to be a battery capacity after a high-temperature storage test. By taking the ratio of the battery capacity before storage to the battery capacity after storage, a high-temperature storage characteristic was determined.

### 4. Overcharge Test

A battery fabricated separately was preliminarily charged with a current density of 0.45 mA/cm² up to 4.3 V. An overcharge test was then performed with a current value of a current density of 1.36 mA/cm² with an upper limit of 7 V. The amount of current flow during overcharge was defined to be an overcharge amount.

The reaction starting voltage of the overcharge inhibitor was determined by comparing a charge curve for a battery which does not contain the overcharge inhibitor with a charge curve for a battery which contains the overcharge inhibitor.

The rate of increase of overvoltage was determined by determining a difference between the reaction starting voltage of the overcharge inhibitor and the upper limit voltage (V) and a charge amount (mAh) required therefor, and taking their ratio (V/mAh). The value was converted into a value per electrode unit area (cm²) and was normalized using a unit (Vcm²/mAh).

When the upper limit of 7 V was not obtained, an overcharge test was performed with an upper limit of 200% of the battery capacity.

After the completion of the overcharge test, the internal resistance of the battery was measured. In the measurement of the internal resistance, the overcharged battery was once discharged to 4.3 V and was charged with a current density of 0.45 mAh/cm² for one minute. The internal resistance (R) was determined from a voltage drop (i E) after a lapse of five seconds from the start of discharge and a current value (I) during the discharge.

Hereinafter, more detailed description will be provided using examples.

### Example 1

4-cyclohexyl styrene (0.27 mol, 50 g), diethylene glycol monomethyl ether methacrylate (0.64 mol, 120 g), and methyl methacrylate (0.09 mol, 9.0 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer A).

Polymer A was added to an electrolytic solution (electrolyte salt: LiPF6, solvent: EC/DMC/EMC=1:1:1 (in volume ratio), an electrolyte salt concentration of 1 mol/L made by Toyama Chemical Co., Ltd.). The concentration of Polymer A was prepared to be 2 wt %. Hereinafter, an electrolytic solution containing Polymer A will be referred to as Electrolytic Solution A.

A battery was fabricated using Electrolytic Solution A, and characteristics evaluation was made therefor, in which Li metal was used for its anode.

As a result, the battery capacity of the battery was 2.4 mAh, the cycle characteristic 0.98, the DC resistance 10Ω, and the high-temperature storage characteristic 0.90.

An overcharge test was performed separately using a battery fabricated under the same conditions.

As a result, the reaction voltage of Polymer A was 4.7 V. A steep increase in overvoltage was observed. Its rate of increase was 2.7 (V/mAh), and was 4.8 (Vcm²/mAh) in terms of current density. Its DC resistance after the overcharge test was 65Ω.

### Example 2

A battery was fabricated in the same manner as Example 1 except for changing the concentration of Polymer A to 5 wt % in Example 1. The battery capacity of the battery was 2.3 mAh, the cycle characteristic 0.97, the DC resistance 15Ω, and the high-temperature storage characteristic 0.88.

An overcharge test was performed separately using a battery fabricated under the same conditions.

As a result, the reaction voltage of Polymer A was 4.7 V. A steep increase in overvoltage was observed. Its rate of increase was 3.0 (V/mAh), and was 5.3 (Vcm²/mAh) in terms of current density. Its DC resistance after the overcharge test was 71Ω.

### Example 3

A battery was fabricated in the same manner as Example 1 except for changing the concentration of Polymer A to 10 wt % in Example 1. The battery capacity of the battery was 2.2 mAh, the cycle characteristic 0.95, the DC resistance 22Ω, and the high-temperature storage characteristic 0.86.

An overcharge test was performed separately using a battery fabricated under the same conditions.

As a result, the reaction voltage of Polymer A was 4.7 V. A steep increase in overvoltage was observed. Its rate of increase was 3.0 (V/mAh), and was 5.3 (Vcm²/mAh) in terms of current density. Its DC resistance after the overcharge test was 73Ω.

### Example 4

4-cyclohexyl styrene (0.27 mol, 50 g), diethylene glycol monomethyl ether methacrylate (0.53 mol, 100 g), and methyl methacrylate (0.20 mol, 20 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer B).

Polymer B was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.). The concentration of Polymer B was prepared to be 2 wt %.

Hereinafter, an electrolytic solution containing Polymer B will be referred to as Electrolytic Solution B.

A battery was fabricated using Polymer B, and characteristics evaluation was made therefor, in which Li metal was used for its anode.

As a result the battery capacity of the battery was 2.4 mAh, the cycle characteristic 0.98, the DC resistance 10Ω, and the high-temperature storage characteristic 0.90.

An overcharge test was performed separately using a battery fabricated under the same conditions.

As a result, the reaction voltage of Polymer B was 4.7 V. A steep increase in overvoltage was observed. Its rate of increase was 3.0 (V/mAh), and was 5.3 (Vcm²/mAh) in terms of current density. Its DC resistance after the overcharge test was 70Ω.

### Example 5

4-cyclohexyl styrene (0.27 mol, 50 g), diethylene glycol monomethyl ether methacrylate (0.53 mol, 100 g), and butyl methacrylate (0.20 mol, 28.4 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer C).

Polymer C was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.). The concentration of Polymer C was prepared to be 2 wt %.

Hereinafter, an electrolytic solution containing Polymer C will be referred to as Electrolytic Solution C.

A battery was fabricated using Polymer C, and characteristics evaluation was made therefor, in which Li metal was used for its anode.

As a result, the battery capacity of the battery was 2.4 mAh, the cycle characteristic 0.95, the DC resistance 16Ω, and the high-temperature storage characteristic 0.90.

An overcharge test was performed separately using a battery fabricated under the same conditions.

As a result, the reaction voltage of Polymer C was 4.7 V. A steep increase in overvoltage was observed. Its rate of increase was 2.4 (V/mAh), and was 4.2 (Vcm²/mAh) in terms of current density. Its DC resistance after the overcharge test was 63Ω.

### Example 6

4-vinyl biphenyl (0.27 mol, 48.6 g), diethylene glycol monomethyl ether methacrylate (0.53 mol, 100 g), and methyl methacrylate (0.20 mol, 28.4 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer D).

Polymer D was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.). The concentration of Polymer D was prepared to be 2 wt %. Hereinafter, an electrolytic solution containing Polymer D will be referred to as Electrolytic Solution D.

A battery was fabricated using Polymer D, and characteristics evaluation was made therefor, in which Li metal was used for its anode.

As a result, the battery capacity of the battery was 2.4 mAh, the cycle characteristic 0.98, the DC resistance 11Ω, and the high-temperature storage characteristic 0.91.

An overcharge test was performed separately using a battery fabricated under the same conditions.

As a result, the reaction voltage of Polymer D was 4.5 V. A steep increase in overvoltage was observed. Its rate of increase was 2.5 (V/mAh), and was 4.4 (Vcm²/mAh) in terms of current density. Its DC resistance after the overcharge test was 60Ω.

### Example 7

Styrene (0.27 mol, 28.1 g), diethylene glycol monomethyl ether methacrylate (0.53 mol, 100 g), and methyl methacrylate (0.20 mol, 28.4 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer E).

Polymer E was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.). The concentration of Polymer E was prepared to be 2 wt.

Hereinafter, an electrolytic solution containing Polymer E will be referred to as Electrolytic Solution E.

A battery was fabricated using Polymer E, and characteristics evaluation was made therefor, in which Li metal was used for its anode.

As a result, the battery capacity of the battery was 2.4 mAh, the cycle characteristic 0.95, the DC resistance 10Ω, and the high-temperature storage characteristic 0.91.

An overcharge test was performed separately using a battery fabricated under the same conditions.

As a result, the reaction voltage of Polymer E was 5.0 V. A steep increase in overvoltage was observed. Its rate of increase was 2.0 (V/mAh), and was 3.5 (Vcm²/mAh) in terms of current density. Its DC resistance after the overcharge test was 33Ω.

### Example 8

A battery was fabricated in the same manner as in Example 4 except for changing the Li metal of the anode for use in the battery evaluation to amorphous carbon in Example 4, and evaluation was made therefor.

As a result, the battery capacity of the battery was 1.5 mAh, the cycle characteristic 0.95, the DC resistance 10Ω, and the high-temperature storage characteristic 0.90.

An overcharge test was performed separately using a battery fabricated under the same conditions.

As a result, the reaction voltage of Polymer B was 4.8 V. A steep increase in overvoltage was observed. Its rate of increase was 2.7 (V/mAh), and was 4.8 (Vcm²/mAh) in terms of current density. Its DC resistance after the overcharge test was 58

### Example 9

4-cyclohexylphenyl acrylate (0.27 mol, 62.1 g), diethylene glycol monomethyl ether methacrylate (0.53 mol, 100 g), and methyl methacrylate (0.20 mol, 28.4 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer F).

Polymer F was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.). The concentration of Polymer F was prepared to be 2 wt %.

Hereinafter, an electrolytic solution containing Polymer F will be referred to as Electrolytic Solution F.

A battery was fabricated using Polymer F, and characteristics evaluation was made therefor, in which Li metal was used for its anode.

As a result, the battery capacity of the battery was 2.4 mAh, the cycle characteristic 0.98, the DC resistance 11Ω, and the high-temperature storage characteristic 0.90.

An overcharge test was performed separately using a battery fabricated under the same conditions.

As a result, the reaction voltage of Polymer F was 4.7 V. A steep increase in overvoltage was observed. Its rate of increase was 2.9 (V/mAh), and was 5.1 (Vcm²/mAh) in terms of current density. Its DC resistance after the overcharge test was 65Ω.

### Example 10

1-cyclohexylphenyl acrylate (0.27 mol, 62.1 g), diethylene glycol monomethyl ether methacrylate (0.53 mol, 100 g), and methyl methacrylate (0.20 mol, 28.4 g) were mixed. Azobisisobutyronitrile (AIBN) as a polymerization initiator was added thereto by 1 wt % with respect to the total monomer weight, and the mixture was stirred until AIBN dissolved. The reaction solution was then sealed and was reacted on a 60° C. oil bath for three hours. After the completion of reaction, the reaction solution was added to 200 mL of methanol to obtain a white precipitate. The solution was then filtrated and was dried in vacuo at 60° C. to obtain a white polymer (Polymer G).

Polymer G was added to an electrolytic solution (electrolyte salt: LiPF₆, solvent: EC/DMC/EMC=1:1:1 (in volume ratio), electrolyte salt concentration of 1 mol/L made by Toyama Chemical Co., Ltd.). The concentration of Polymer G was prepared to be 2 wt %.

Hereinafter, an electrolytic solution containing Polymer G will be referred to as Electrolytic Solution G.

A battery was fabricated using Polymer G, and characteristics evaluation was made therefor, in which Li metal was used for its anode.

As a result, the battery capacity of the battery was 2.4 mAh, the cycle characteristic 0.98, the DC resistance 11Ω, and the high-temperature storage characteristic 0.92.

An overcharge test was performed separately using a battery fabricated under the same conditions.

As a result, the reaction voltage of Polymer G was 4.7 V. A steep increase in overvoltage was observed. Its rate of increase was 2.9 (V/mAh), and was 5.1 (Vcm²/mAh) in terms of current density. Its DC resistance after the overcharge test was 62Ω.

In the above examples, the internal resistance increases during battery overcharge, and the overvoltage increases steeply.

This is because the above polymer (overcharge inhibitor) does not undergo reaction within the range of the operating voltage of the battery and has functions of starting electrolytic polymerization, increasing the internal resistance of the battery, and shutting down the battery reaction when it becomes an overcharge state.

This action facilitates detection of the reaction voltage of the above polymer, thereby allowing the overcharge of the battery to be detected and providing a highly safe lithium ion battery.

### Comparative Example 1

Trans-stilbene was added to an electrolytic solution (electrolyte salt: LiPF₆, solvent: EC/DMC/EMC=1:1:1 (in volume ratio), an electrolyte salt concentration of 1 mol/L made by Toyama Chemical Co, Ltd.) to give 2 wt %. Using the electrolytic solution, a battery was fabricated, in which Li metal was used for its anode.

The battery capacity of the fabricated battery was 2.0 mAh, the cycle characteristic 0.85, the DC resistance 15Ω, and the high-temperature storage characteristic 0.50.

An overcharge test was performed separately using a battery fabricated under the same conditions. As a result, no increase in overvoltage was observed. The DC resistance after the overcharge test was 20Ω.

### Comparative Example 2

Cyclohexyl benzene was added to an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.) to give 2 wt %. Using the electrolytic solution, a battery was fabricated, in which Li metal was used for its anode.

The battery capacity of the fabricated battery was 2.4 mAh, the cycle characteristic 0.93, the DC resistance 15Ω, and the high-temperature storage characteristic 0.75.

An overcharge test was performed separately using a battery fabricated under the same conditions. No increase in overvoltage was observed. The DC resistance after the overcharge test was 14Ω.

### Comparative Example 3

A battery was fabricated using an electrolytic solution (electrolyte salt: LiPF₆, solvent: EC/DMC/EMC=1:1:1 (in volume ratio), an electrolyte salt concentration of 1 mol/L made by Toyama Chemical Co., Ltd.) with no additive added, in which Li metal was used for its anode.

The battery capacity of the fabricated battery was 2.4 mAh, the cycle characteristic 0.98, the DC resistance 8Ω, and the high-temperature storage characteristic 0.87.

An overcharge test was performed separately using a battery fabricated under the same conditions. No increase in overvoltage was observed. The DC resistance after the overcharge test was 20Ω.

### Comparative Example 4

A battery was fabricated in the same manner as Comparative Example 3 except for using amorphous carbon instead of Li metal for the anode in Comparative Example 3.

The battery capacity of the battery was 1.5 mAh, the cycle characteristic 0.95, the DC resistance 9Ω, and the high-temperature storage characteristic 0.86.

An overcharge test was performed separately using a battery fabricated under the same conditions.

No increase in overvoltage was observed. The DC resistance after the overcharge test was 210.

Table 1 summarizes the above examples and comparative examples.

TABLE 1

| | | | | | | | | | | | | | | | | | Rate of | |
|---|---|---|---|---|---|---|---|---|---|---|---|---|---|---|---|---|---|---|
| | | | | | | | | Polymer | | | | DC | | High- | | | increase | DC |
| | Chemical | | | a | b | c | Name | concen- | | | Battery | resistance | Cycle | temperature | Reaction | | V/mAh | resistance |
| Exam- | formula | Chemical | Chemical | (mol | (mol | (mol | of | tration | | | capacity/ | (before | charac- | storage | starting | Increase in | (Vcm²/ | (after |
| ple | (1) or (2) a | formula (3) b | formula (4) c | %) | %) | %) | polymer | wt % | Cathode | Anode | mAh | overcharge) | teristic | characteristic | voltage/V | overvoltage | mAh) | overcharge) |
| 1 | 4-cyclohexyl | diethylene glycol | methyl | 27 | 64 | 9 | Polymer | 2 | LiCoO₂ | Li metal | 2.4 | 10 | 0.98 | 0.90 | 4.7 | ∘ | 2.7 | 65 |
| | styrene | monomethyl ether | methacrylate | | | | A | | | | | | | | | | (4.8) | |
| | | methacrylate | | | | | | | | | | | | | | | | |
| 2 | 4-cyclohexyl | diethylene glycol | methyl | 27 | 64 | 9 | Polymer | 5 | LiCoO₂ | Li metal | 2.3 | 15 | 0.97 | 0.88 | 4.7 | ∘ | 3.0 | 71 |
| | styrene | monomethyl ether | methacrylate | | | | A | | | | | | | | | | (5.3) | |
| | | methacrylate | | | | | | | | | | | | | | | | |
| 3 | 4-cyclohexyl | diethylene glycol | methyl | 27 | 64 | 9 | Polymer | 10 | LiCoO₂ | Li metal | 2.2 | 22 | 0.95 | 0.86 | 4.7 | ∘ | 3.0 | 73 |
| | styrene | monomethyl ether | methacrylate | | | | A | | | | | | | | | | (5.3) | |
| | | methacrylate | | | | | | | | | | | | | | | | |
| 4 | 4-cyclohexyl | diethylene glycol | methyl | 27 | 53 | 20 | Polymer | 2 | LiCoO₂ | Li metal | 2.4 | 10 | 0.98 | 0.90 | 4.7 | ∘ | 3.0 | 70 |
| | styrene | monomethyl ether | methacrylate | | | | B | | | | | | | | | | (5.3) | |
| | | methacrylate | | | | | | | | | | | | | | | | |
| 5 | 4-cyclohexyl | diethylene glycol | butyl | 27 | 53 | 20 | Polymer | 2 | LiCoO₂ | Li metal | 2.4 | 16 | 0.95 | 0.90 | 4.7 | ∘ | 2.4 | 63 |
| | styrene | monomethyl ether | methacrylate | | | | C | | | | | | | | | | (4.2) | |
| | | methacrylate | | | | | | | | | | | | | | | | |
| 6 | 4-vinyl | diethylene glycol | methyl | 27 | 53 | 20 | Polymer | 2 | LiCoO₂ | Li metal | 2.4 | 11 | 0.98 | 0.91 | 4.5 | ∘ | 2.5 | 60 |
| | biphenyl | monomethyl ether | methacrylate | | | | D | | | | | | | | | | (4.4) | |
| | | methacrylate | | | | | | | | | | | | | | | | |
| 7 | styrene | diethylene glycol | methyl | 27 | 53 | 20 | Polymer | 2 | LiCoO₂ | Li metal | 2.4 | 10 | 0.95 | 0.91 | 5.0 | ∘ | 2.0 | 33 |
| | | monomethyl ether | methacrylate | | | | E | | | | | | | | | | (3.5) | |
| | | methacrylate | | | | | | | | | | | | | | | | |
| 8 | 4-cyclohexyl | diethylene glycol | methyl | 27 | 53 | 20 | Polymer | 2 | LiCoO₂ | Amor- | 1.5 | 10 | 0.95 | 0.90 | 4.8 | ∘ | 2.7 | 58 |
| | styrene | monomethyl ether | methacrylate | | | | B | | | phous | | | | | | | (4.8) | |
| | | methacrylate | | | | | | | | carbon | | | | | | | | |
| 9 | 4-cylcohexyl | diethylene glycol | methyl | 27 | 53 | 20 | Polymer | 2 | LiCoO₂ | Li metal | 2.4 | 11 | 0.98 | 0.90 | 4.7 | ∘ | 2.9 | 65 |
| | phenyl | monomethyl ether | methacrylate | | | | F | | | | | | | | | | (5.1) | |
| | acrylate | methacrylate | | | | | | | | | | | | | | | | |
| 10 | 1-cyclohexyl | diethylene glycol | methyl | 27 | 53 | 20 | Polymer | 2 | LiCoO₂ | Li metal | 2.4 | 11 | 0.98 | 0.92 | 4.7 | ∘ | 2.9 | 62 |
| | phenyl | monomethyl ether | methacrylate | | | | G | | | | | | | | | | (5.1) | |
| | acrylate | methacrylate | | | | | | | | | | | | | | | | |

| | | | | | | | | | Battery | DC resistance | | High-temperature | Reaction | | Rate of increase | DC resistance |
|---|---|---|---|---|---|---|---|---|---|---|---|---|---|---|---|---|
| Comparative | | | | | | Concentration/ | | | capacity/ | (before | Cycle | storage | starting | Increase in | V/mAh | (after |
| Example | | | | | | wt % | Cathode | Anode | mAh | overcharge) | characteristic | characteristic | voltage/V | overvoltage | (Vcm²/mAh) | overcharge) |
| 1 | trans-stilbene | — | — | — | — | 2 | LiCoO₂ | Li metal | 2.0 | 15 | 0.85 | 0.50 | — | x | — | 20 |
| 2 | cyclohexyl | — | — | — | — | 2 | LiCoO₂ | Li metal | 2.4 | 15 | 0.93 | 0.75 | 4.6 | x | — | 14 |
| | benzene | | | | | | | | | | | | | | | |
| 3 | only | — | — | — | — | — | LiCoO₂ | Li metal | 2.4 | 8 | 0.98 | 0.87 | — | x | — | 20 |
| | electrolytic | | | | | | | | | | | | | | | |
| | solution | | | | | | | | | | | | | | | |
| 4 | only | — | — | — | — | — | LiCoO₂ | Amorphous | 1.5 | 9 | 0.95 | 0.86 | — | x | — | 21 |
| | electrolytic | | | | | | | carbon | | | | | | | | |
| | solution | | | | | | | | | | | | | | | |

Hereinafter, the configuration of secondary batteries of the embodiments will be described with reference to drawings.

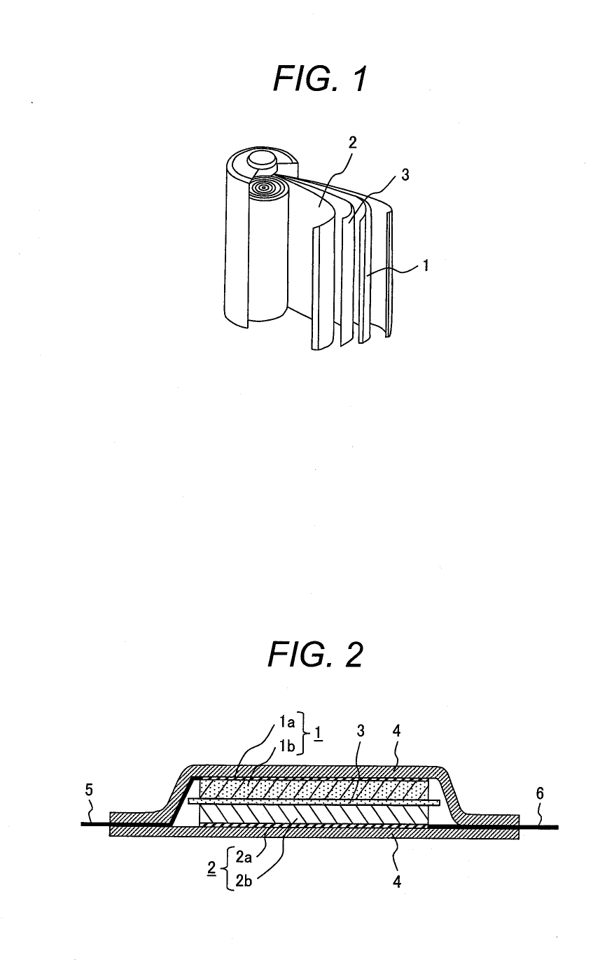

FIG. 1 is an exploded perspective view showing a secondary battery (a tubular lithium ion battery) of an embodiment.

The secondary battery shown in the drawing has a structure in which a cathode 1 and an anode 2 are stacked with a separator 3 arranged between them, are wound, and are encapsulated in a battery can 101 together with a nonaqueous electrolytic solution. A cathode terminal 102 electrically connected to the cathode 1 is provided at the central part of a battery lid 103. The battery can 101 is electrically connected to the anode 2.

FIG. 2 is a sectional view showing a secondary battery (a laminated cell) of another embodiment.

The secondary battery shown in the drawing has a structure in which a cathode 1 and an anode are stacked with a separator 3 arranged between them, and are sealed with a packaging member 4 together with a nonaqueous electrolytic solution. The cathode 1 includes a cathode current collector 1a and a cathode mixture layer 1b, while the anode 2 includes an anode current collector 2a and an anode mixture layer 2b. The cathode current collector 1a is connected to a cathode terminal 5, while the anode current collector 2a is connected to an anode terminal 6.

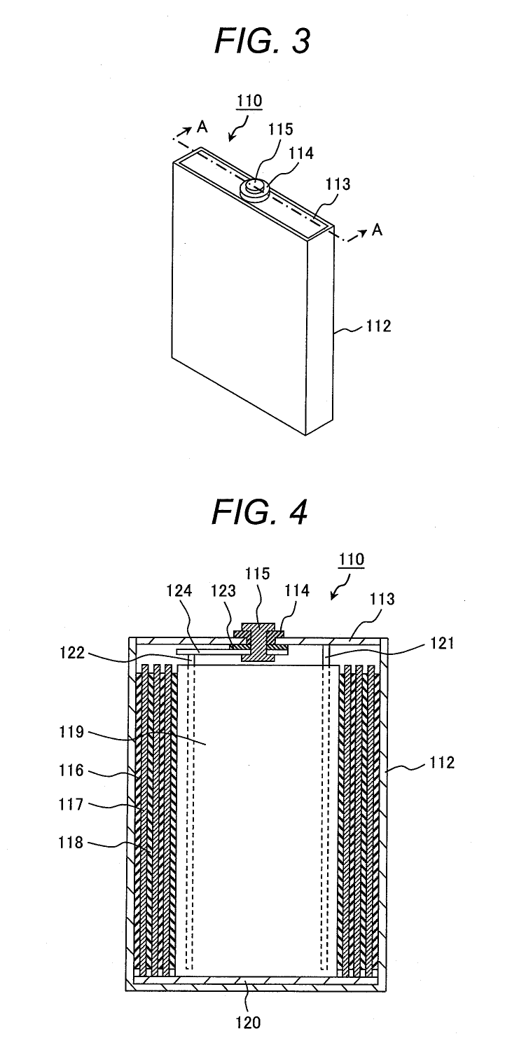

FIG. 3 is a perspective view showing a secondary battery (a square battery) of another embodiment.

In the drawing a battery 110 (a nonaqueous electrolytic solution secondary battery) is configured by encapsulating a flat wound electrode member in a square exterior can 112 together with a nonaqueous electrolytic solution. A terminal 115 is provided at the central part of a lid plate 113 through an insulator 114.

FIG. 4 is an A-A cross-sectional view of FIG. 3.

In the drawing a cathode 116 and an anode 118 are wound with a separator 117 arranged between them to form a flat wound electrode member 119. An insulator 120 is provided at the bottom of the exterior can 112 in order to avoid shorting of the cathode 116 and the anode 118.

The cathode 116 is connected to the lid plate 113 through a cathode lead member 121, while the anode 118 is connected to the terminal 115 through an anode lead member 122 and a lead plate 124. An insulator 123 is disposed to avoid direct contact between the lead plate 124 and the lid plate 113.

The structures of the secondary batteries of the above embodiments are only examples, and the secondary battery of the present invention is not limited thereby, including all ones to which the above overcharge inhibitor is applied.

What is claimed is:

1. A polymer obtained by polymerizing:
a polymerizable compound represented by the following chemical formula (1) or chemical formula (2); a polymerizable compound represented by the following chemical formula (3); and a polymerizable compound represented by the following chemical formula (4),
Z¹—X-A chemical formula (1)
Z¹-A chemical formula (2)
Z²—Y chemical formula (3)
Z³—W chemical formula (4)
wherein Z¹ is a polymerizable functional group, X is a hydrocarbon group or an oxyalkylene group having a carbon number of 1 to 20, A is an aromatic functional group, Z² is a polymerizable functional group, Y is a highly polar functional group, Z³ is a polymerizable functional group, and W is a less polar functional group.

2. A polymer represented by the following chemical formula (5) or chemical formula (6), 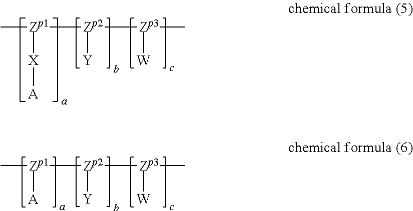
wherein Z^{p1} is a residue of a polymerizable functional group, X is a hydrocarbon group or an oxyalkylene group having a carbon number of 1 to 20, A is an aromatic functional group, Z^{p2} is a residue of a polymerizable functional group, Y is a highly polar functional group, Z^{p3} is a residue of a polymerizable functional group, W is a less polar functional group, and a, b and c represent mol %.

3. The polymer according to claim 2,
wherein the chemical formula (6) is represented by the following chemical formula (7), 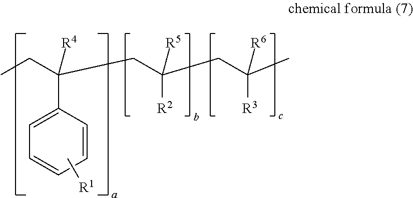
wherein R¹ is a hydrogen atom, an aliphatic hydrocarbon, an alicyclic hydrocarbon, or an aromatic group, R² is a functional group having alkylene oxide, a cyano group, an amino group or a hydroxyl group, and R³ is a functional group having an aliphatic hydrocarbon or an alicyclic hydrocarbon group.

4. A lithium secondary battery comprising a cathode, an anode, and an electrolyte,
wherein the electrolyte contains the polymer according to claim 1.

5. A lithium secondary battery comprising a cathode, an anode, and an electrolyte,
wherein the electrolyte contains the polymer according to claim 2.

6. A lithium secondary battery comprising a cathode, an anode, and an electrolyte,
wherein the electrolyte contains the polymer according to claim 3.

7. An electrolytic solution for a lithium secondary battery, containing the polymer according to claim 1, claim 2 or claim 3.

8. An overcharge inhibitor for a lithium secondary battery, containing the polymer according to claim 1, claim 2 or claim 3 as an active component.

9. A method for producing a polymer comprising the steps of:
mixing a polymerizable compound represented by the following chemical formula (1) or chemical formula (2) and polymerizable compounds represented by the following chemical formulae (3) and (4); and
mixing a polymerization initiator thereinto to cause a reaction,
Z¹—X-A chemical formula (1)
Z¹-A chemical formula (2)
Z²—Y chemical formula (3)
Z³—W chemical formula (4)
wherein Z′ is a polymerizable functional group, X is a hydrocarbon group or an oxyalkylene group having a carbon number of 1 to 20, A is an aromatic functional group, Z² is a polymerizable functional group, Y is a highly polar functional group, Z³ is a polymerizable functional group, and W is a less polar functional group.

10. The method according to claim 9,
wherein the chemical formula (2) is the following chemical formula (8),
the chemical formula (3) is the following chemical formula (9), and
the chemical formula (4) is represented by the following chemical formula (10), 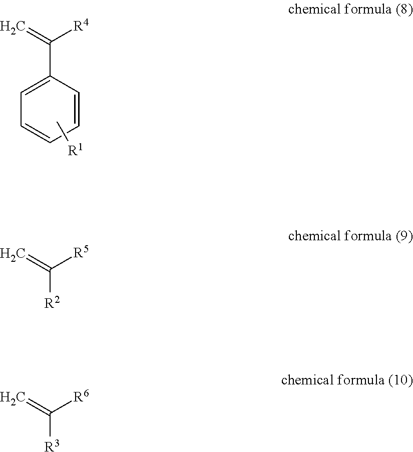
wherein R¹ is a hydrogen atom, an aliphatic hydrocarbon, an alicyclic hydrocarbon, or an aromatic group, R² is a functional group having alkylene oxide, a cyano group, an amino group or a hydroxyl group, R³ is a functional group having an aliphatic hydrocarbon or an alicyclic hydrocarbon group, and R⁴, R⁵ and R⁶ are each a hydrogen atom or a hydrocarbon group.

11. A charge control method for a lithium secondary battery comprising the steps of:
using the electrolytic solution according to claim 5;
determining a completion of charging by detecting an increase in overvoltage; and
terminating an application of voltage.

12. A lithium secondary battery containing the electrolytic solution according to claim 7, having a control unit which determines a completion of charging by detecting an increase in overvoltage and terminates an application of voltage.
